(19) United States
(12) Patent Application Publication
(10) Pub. No.: US 2014/0331608 A1
(43) Pub. Date: Nov. 13, 2014

(54) APPARATUS AND METHOD OF MAKING BIO LOGS

(71) Applicant: Certified Erosion Control of New Hampshire, LLC, Goffstown, NH (US)

(72) Inventors: David J. Letourneau, Goffstown, NH (US); John Eaton, Weare, NH (US); Chris Bouchard, Weare, NH (US)

(73) Assignee: Certified Erosion Control of New Hampshire, LLC, Goffstown, NH (US)

(21) Appl. No.: 14/272,571

(22) Filed: May 8, 2014

Related U.S. Application Data
(60) Provisional application No. 61/821,778, filed on May 10, 2013.

(51) Int. Cl. A01F 15/04; B30B 15/30; E02B 3/12

(52) U.S. Cl. CPC A01F 15/04; E02B 3/121; E02B 3/129; B30B 15/302
USPC 53/436; 100/188 R; 53/527; 53/567

(57) ABSTRACT

A machine for making bio logs includes a conduit with a feed opening along a top side and a chamber below the feed opening. A door over the feed opening is movable between open and closed positions by a first piston connected to the door. A plunger disposed within the conduit is movable between a retracted position and an extended position by a second piston connected to the plunger. A method of making bio logs includes retracting the first piston to move the door to the open position, retracting the second piston to move the piston to the retracted position, disposing a quantity of filling material into the chamber, extending the first piston to move the door to the closed position, and extending the second piston to move the plunger to the extended position.

### BACKGROUND OF THE INVENTION

1. Field of the Invention

The present invention relates generally to industrial equipment and more particularly to an apparatus and method for making bio logs.

2. Description of the Prior Art

Straw wattles are tubes of compressed straw encased in a flexible netting material of jute, nylon, or other materials. Also known bio logs, straw worms, straw noodles, and straw tubes, wattles typically have a diameter of about 9 inches and a length of 25-30 feet. Wattles may be installed in a shallow trench that extends across a slope so that the wattles form a barrier to intercept water running down the slope. Wattles promote vegetation growth by reducing erosion, adding roughness to a slope, and helping to retain eroded soil on a slope.

Wattles were once filled with straw by hand. More recently, machines have been developed to make straw wattles. One machine is disclosed in U.S. Pat. No. 5,519,985 to Dyck et al. The '985 patent discloses an apparatus and method of filling tubes of flexible, large mesh, netting material with compacted rice straw or the like. Using an inclined table, loose rice straw is fed into an auger encompassed by a steel pipe. The auger advances the straw through the steep pipe and into a tube of mesh or netting material. The netting is closed on its forward end and the balance of the netting tube is initially gathered on the outside of the steel pipe so that when the auger continuously urges straw into the netting, the gathered portions of the netting tube are advanced and stripped from the pipe. When the after end of the straw-filled tube clears the pipe, the after end of the filled tube is closed and the completed product is removed to allow commencement of the next cycle.

Other equipment used to make straw wattles include a blower to fill netting tubes. In one machine, a bale of straw is fed into the machine where it is broken apart into small pieces and blown through a discharge chute into a tube made of netting.

### SUMMARY OF THE INVENTION

Unfortunately, the auger-based apparatus described above produces straw wattles at a top rate of about 300 feet per hour. This production rate has proved to be undesirably low for efficient and cost-effective wattle production. As a result, one must purchase many wattle making machines in order to keep up with high production demands. Unfortunately, the machines are quite expensive with a price of $30K to $50K or more. Because of high costs of obtaining more machines, and the space required to house the machines, wattle manufacturers refrain from expanding production by increasing the number of machines. Without being able to add more equipment to keep up with demand, the low production rate of straw wattles made with an auger-based apparatus causes production backlogs and delivery delays for large orders of straw wattles.

Auger-based wattle machines also require that the straw be broken into short pieces (e.g., 2-4″). Due to the short straw pieces and crumbs of straw left over from the process, auger-based machines produce a lot of dust. Also, currently-available auger-based machines produce wattles of inconsistent fill density and have proved to be inadequate in terms of construction quality, durability, and required maintenance.

In practice, straw blower machines described above are only usable outdoors due to the large amounts of dust and debris that results from the blower machine. In addition to producing significant dust, straw blowers are ill-suited for efficiently filling tubes and therefore do a poor job of making straw wattles.

Therefore, a need exists for an improved apparatus and method for making straw wattles and other filled-tube items.

It is an object of the present invention to provide an apparatus and method for filling flexible tubes with a filling material.

It is another object of the present invention to improve the efficiency of straw wattle manufacturing.

It is another object of the present invention to provide an apparatus for making straw wattles that exhibits improved operation and durability over currently-available machines.

The present invention achieves these and other objectives by providing an apparatus and method of making bio logs. In one embodiment an apparatus for making a bio log includes a conduit having a forward end, a rearward end, and defines a chamber with a feed opening along a top surface of the conduit. The forward end is configured to attach to or receive a quantity of flexible tube to be filled with filling material. A door disposed on the conduit is configured to open and close the feed opening by sliding along the conduit from a first door position to a second door position. A first piston is connected to the door and configured to reciprocally move the door between the first door position where the feed opening is substantially unobstructed by the door. In the second door position, the feed opening is substantially closed by the door. A plunger disposed within the conduit and movable between a first plunger position and a second plunger position. A second piston connected to the plunger is configured to reciprocally move the piston through chamber between a first plunger position and a second plunger position.

In another embodiment, the apparatus includes a hopper disposed above the feed opening.

In another embodiment, a first hydraulic pump connected to the first piston and a second hydraulic pump connected to the second piston.

In another embodiment, the first piston and the second piston are each piped in a hydraulic regeneration circuit.

In another embodiment, the apparatus includes a controller configured to operate the first piston and the second piston in a repeating cycle.

In another embodiment, the conduit defines at least one exhaust opening. In one embodiment, the exhaust opening(s) is (are) connected to a vacuum line or system.

In another embodiment, the apparatus includes a material dispenser disposed above the feed opening, where the material dispenser including a paddle, an auger, a conveyor, or a hopper.

In another aspect of the present invention, a method of making a filled-tube product includes disposing a quantity of filling material into the chamber; advancing the door to the closed door position; extending the plunger at least partially through the chamber in the direction of the forward end portion, thereby pushing the filling material towards the forward-end opening and the flexible tube; retracting the plunger from the chamber; and retracting the door to the open door position.

In one embodiment of the method, the steps of disposing a quantity of filling material, advancing the door to the closed door position, extending the plunger through the chamber, and retracting the plunger from the chamber, and retracting the door to the open door position comprise one cycle of the method.

In another embodiment of the method, the steps of extending the plunger and retracting the plunger are performed with a first hydraulic piston connected to the plunger and the steps of retracting the door and advancing the door are performed with a second hydraulic piston connected to the door.

In another embodiment, the method also includes installing one end of a flexible tube over a forward end portion of the longitudinal conduit. In another embodiment, the method also includes closing a forward end of the flexible tube.

In another embodiment, the method also includes operating the first hydraulic piston in a regeneration circuit and operating the second hydraulic piston in a regeneration circuit.

In one embodiment, one cycle of the method is performed in less than six seconds.

In another embodiment, the method also includes the steps of repeating the cycle a predetermined number of times, pausing the method for a predetermined length of time, and starting the method again for a subsequent predetermined number of cycles.

### BRIEF DESCRIPTION OF THE DRAWINGS

FIG. 1 illustrates a perspective view of one embodiment of a machine of the present invention showing components of the machine and hydraulic assembly.

FIG. 2 illustrates a piping diagram for one embodiment of a hydraulic assembly of the present invention, showing the first and second pistons piped in regeneration circuits.

FIG. 3 illustrates a perspective view of another embodiment of a machine of the present invention shown with a paddle system.

FIG. 4A illustrates a perspective view of the machine of FIG. 1 showing the door in a closed door position.

FIG. 4B illustrates a perspective view of the machine of FIG. 1 showing the door in an open door position.

FIG. 5 is a front, perspective view of the machine of FIG. 1 showing the feed opening and chamber with the door in an open door position.

FIG. 6A illustrates a perspective view of the machine of FIG. 1 showing the conduit cutaway with the first and second pistons in an open or first position.

FIG. 6B illustrates perspective view of the machine of FIG. 1 showing the conduit cutaway with the first and second pistons in a closed or second position.

FIG. 7 is a perspective view of one embodiment of a second piston and plunger of the present invention showing a piston rod attached to one embodiment of a plunger with a plunger face plate.

FIG. 8 illustrates a side view of one embodiment of a second piston and plunger of the present invention showing an exhaust opening and the plunger disposed within the conduit.

FIG. 9 is a flow chart illustrating steps performed in one embodiment of a method of making a filled-tube product.

FIG. 10 is a perspective of an exemplary embodiment of a machine used to make bio logs and other filled-tube products shown with filling material and a flexible tube to be filled with the filling material.

### DETAILED DESCRIPTION OF THE EMBODIMENTS

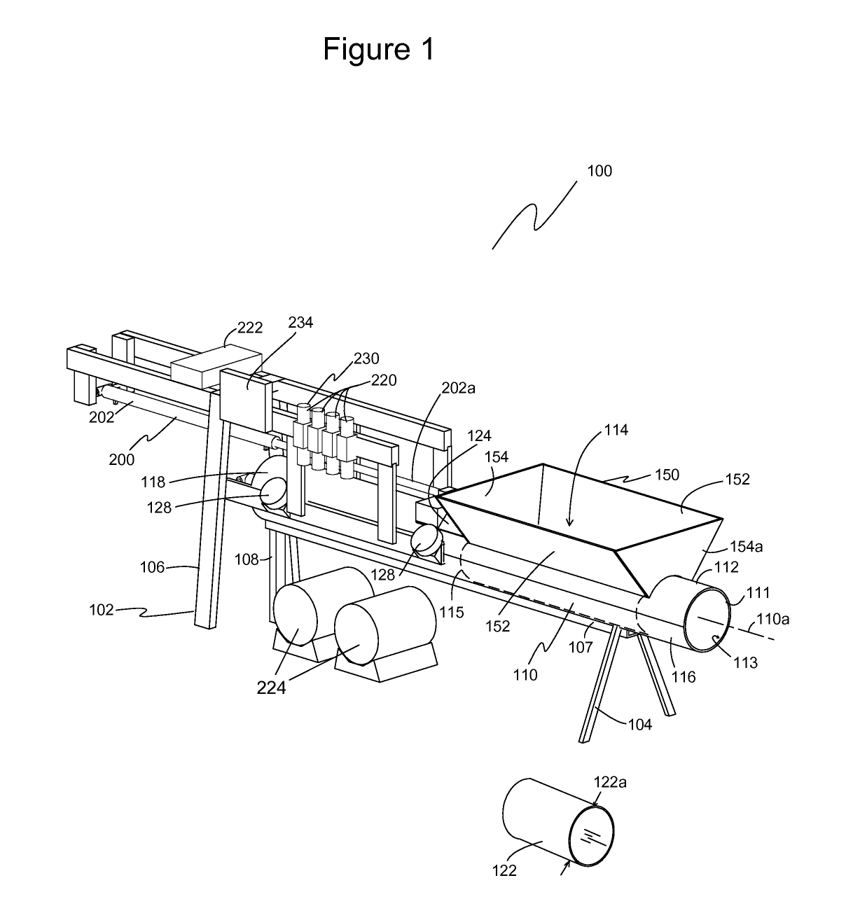

Embodiments of the present invention are illustrated in FIGS. 1-10. FIG. 1 is a perspective illustration of one embodiment of a machine 100 used for making bio logs and other filled-tube products. Machine 100 includes a frame 102, a conduit 110, a hydraulic assembly 200, and a hopper 150. Machine 100 optionally includes a regeneration control unit 222 and an electronic controller 234.

In one embodiment, frame 102 includes a first support member 104, a second support member 106, and one or more longitudinal frame members 107 extending between and connecting support members 104, 106. Support members 104, 106 shown here are steel A-frame-type supports with a pair of spaced-apart legs that extend from the ground towards longitudinal member 107 and forming a triangle or trapezoid shape with the ground. Frame 102 optionally includes one or more additional support members 108, such as a vertical support or cross piece connected to longitudinal member 107 and/or support members 104, 106.

A longitudinal conduit 110 is supported by frame 102 and extends along a central longitudinal axis 110a. Conduit 110 has a forward end portion 116 and a rearward end portion 118. Filling material is discharged from forward-end opening 111 at forward end portion 116 to fill a flexible tube. Conduit 110 has a feed opening 114 (not visible) in a conduit top surface 112. In one embodiment, feed opening 114 is about four feet in length and is positioned below a hopper 150 that supplies filling material, such as straw. Conduit 110 defines an open chamber 115 within conduit 110 and below feed opening 114. In one embodiment, conduit 110 is a pipe or tube made of schedule 80 steel or other rigid material with a diameter from about 8 inches to about 20 inches and a length of about 10 feet. Some diameters useful for making straw wattles include 8″, 9″, 12″, 18″, and 20″ diameters. Other sizes and shapes of conduit 110 are acceptable, such as a rectangular, triangular, or other cross-sectional shape.

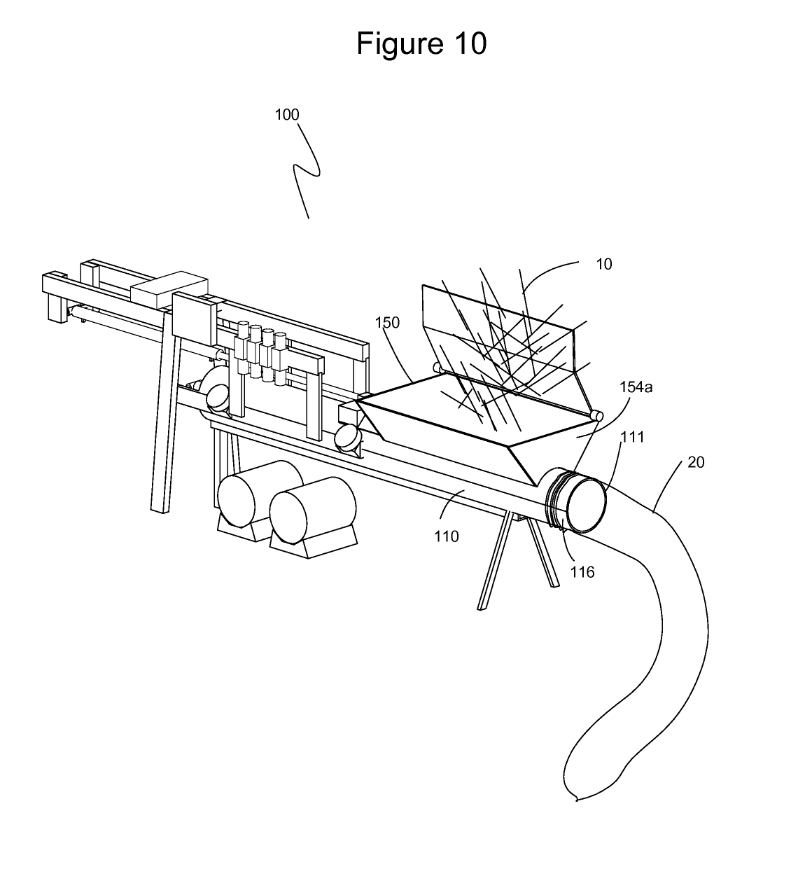

Forward end portion 116 is configured to receive, connects to, or be received by a flexible tube 20 (shown in FIG. 10) to be filled with filling material, such as a tube made of netting or fabric for making straw wattles. Forward end portion 116 optionally includes a removable extension insert 122 that is sized and shaped to fit along inside surface 113 of conduit 110. When conduit 110 is cylindrical, an outer diameter 122a of extension insert is substantially the same as inner diameter 121 of conduit 110. Extension insert 122 extends into forward end portion 116 approximately eight inches, but not beyond the maximum forward position of a plunger 206 operating in conduit 110. This maximum forward position typically corresponds to the position of front end plate 154a of hopper 150. Extension insert 122 is installed in forward end portion 116 of conduit 110 to facilitate installing flexible tube 20 (not shown) over conduit 110 and to extend conduit 110 to accommodate different lengths of flexible tube 20. In one embodiment, forward end portion 116 extends forward of hopper 150 between about one to six feet, including extension insert 122.

A hopper 150 is attached to or positioned atop conduit 110 to direct straw or other filling material 10 through feed opening 114 and into chamber 115. In one embodiment, hopper 150 has a pair of angled sidewalls 152 and a pair of substantially parallel end plates 154. Sidewalls 152 and end plates 154 are attached (e.g., by welding) to form an open, rectangular or trapezoidal chute directed towards feed opening 114 and into chamber 115 of conduit 110. In one embodiment, hopper 150 is made of ½″-thick steel or other rigid material.

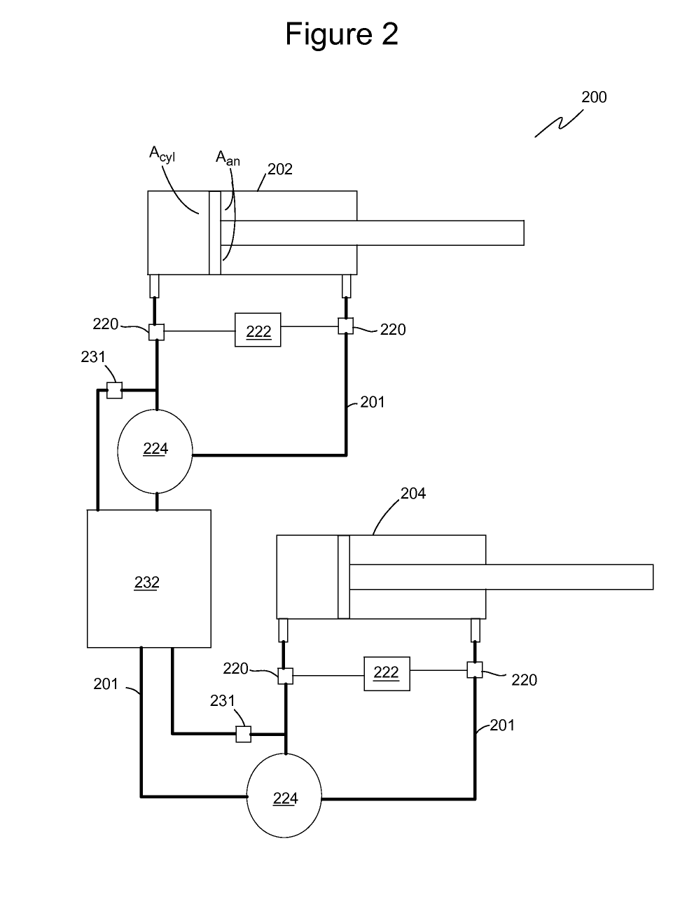

Machine 100 also includes a hydraulic assembly 200. Components of hydraulic assembly 200 are illustrated in FIG. 1 as well as shown schematically in a piping diagram in FIG. 2. In one embodiment, hydraulic assembly 200 is a DO5 hydraulic system that includes a pressure-sensitive regeneration valve controller 222, hydraulic pumps 224, a DO5 high-flow valve manifold 230 with relief valve 231 (shown in FIG. 2) and flow valves 220, a first piston 202, a second piston 204 (shown in FIGS. 2 & 5 and discussed below), and a hydraulic fluid reservoir 232 (shown in FIG. 2). Preferably, valve manifold 230 is attached to frame 102 for connecting hydraulic lines between hydraulic pumps 224, first piston 202, second piston 204, and regeneration valve controller 222.

In one embodiment, hydraulic pumps 224 have 50-75 HP motors rated for 30 GPM at 1780 RPM and 3500 PSIG maximum hydraulic pressure. In another embodiment, hydraulic pumps 224 are rated for 63 GPM at 1780 RPM, and 3000 PSIG maximum hydraulic pressure. Other configurations are acceptable as needed for the desired speed and performance of machine 100. Piping first and second pistons 202, 204 with a regeneration circuit is optional, but is preferred to increase hydraulic pressure and to maintain a more even hydraulic pressure in hydraulic assembly 200. Also, a regeneration circuit enables faster operation of a hydraulic piston.

FIG. 2 illustrates one acceptable piping diagram for hydraulic assembly 200 using a regeneration circuit as is known in the art. In one embodiment, hydraulic lines 201 have a size of 1.25″-1.5″. Flow valves 233 preferably are made of ductile iron to prevent cavitation and corrosion due to rapid pressure changes during operation. When hydraulic assembly 200 is configured with a regeneration circuit, piston cylinder area, A_{cyl}, is preferably about twice the area of the piston annulus, Aₐₙ. That is, A_{cyl}=2Aₐₙ for each of first piston 202 and second piston 204.

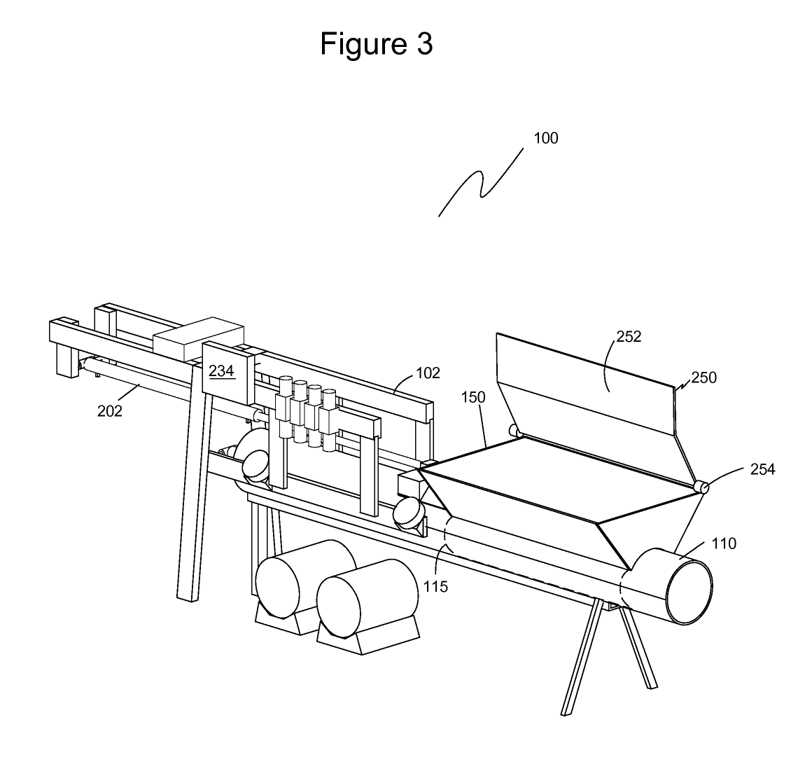

Referring now to FIG. 3, some embodiments of machine 100 include a rotary paddle system 250 to assist with pushing filling material (e.g., straw) into chamber 115. In one embodiment, a paddle 252 is operatively connected to a drive shaft 254, such as an auger shaft, that rotates paddle 252 from a first paddle position (shown in FIG. 3) about 45° to 180° to a second paddle position to press the filling material into chamber 115. In another embodiment, drive shaft 254 rotates paddle 252 by about 90° to about 120° between first paddle position and second paddle position. Paddle 252 is then rotated back to the first paddle position. In one embodiment, rotary paddle system 250 is driven by a hydraulic pump 224 with a regeneration circuit. Rotary paddle system 250 can be a stand-alone unit or can be attached to machine 100, such as to hopper 150, frame 102, or conduit 110.

Machine 100 optionally includes an electronic controller 234 that is programmable to actuate extension and retraction of first and second pistons 202, 204 with a desired timing. When rotary paddle system 250 is included, controller 234 controls first and second pistons 202, 204 synchronously with paddle 252 or other material feed apparatus. In one embodiment, machine 100 operates each cycle within about 5-6 seconds. The machine cycle is discussed further below.

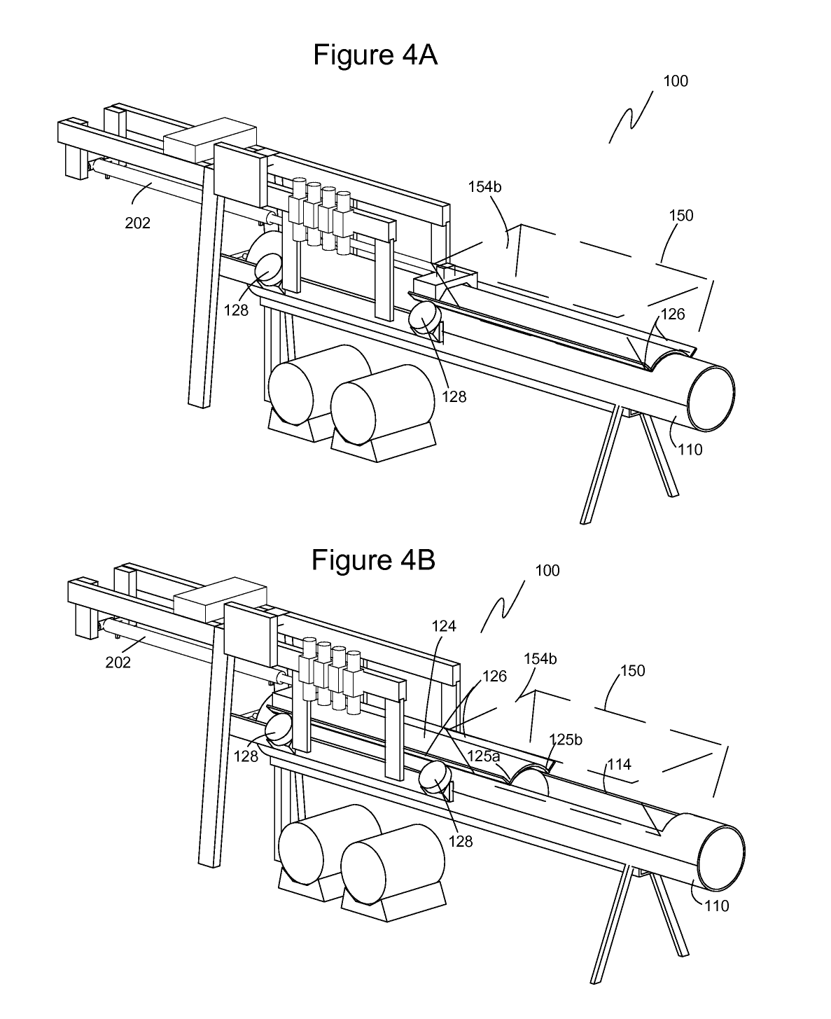

Referring now to FIGS. 4A and 4B, perspective illustrations show machine 100 with hopper 150 shown in broken lines for clarity. Door 124 is moved by first piston 202 between a first door position (e.g., open) and a second door position (e.g., closed). In the second door position (closed) as shown in FIG. 4A, door 124 extends through rear end plate 154b of hopper 150 and covers feed opening 114 in conduit 110. In the first door position (open) shown in FIG. 4B, door 124 is retracted to uncover feed opening 114.

In one embodiment, door 124 is an elongated plate with a shape configured to mate with and slide along conduit 110 (e.g., curved). In another embodiment, door 124 has one or more guide flanges 126 or protrusions that extend from a door top surface 124a. In an embodiment where door 124 is a portion of a cylinder, guide flanges 126 are welded to and extend radially from door top surface 124a proximate first side portion 125a and second side portion 125b. Guide flanges 126 extend longitudinally along all or substantially all of the length of door 124. As door 124 moves between the first door position and the second door position, guide members 128 contact door 124 or guide flanges 126 to facilitate longitudinal movement with reduced friction and improved stability. Guide members 128 may be, for example, rollers, wheels, bearings, or low-friction materials (e.g., PTFE) attached to opposite sides of frame 102 or conduit 110.

In one embodiment, door 124 is sized to be significantly longer than feed opening 114 for more balanced movement by first piston 202. Accordingly, in one embodiment, a midpoint of door 124 is proximate rear end plate 154b when door 124 is in its closed position. As door 124 moves into its closed position, a forward edge 124a of door 124 slides along or against a sharpened edge 114a of feed opening 114 to cut any filling material 10 (e.g., straw) that extends out of chamber 115. When protruding filling material 10 is cut, it does not extend through feed opening 114 and therefore is less prone to jam machine 110 or become entangled with door 124 or second piston 204.

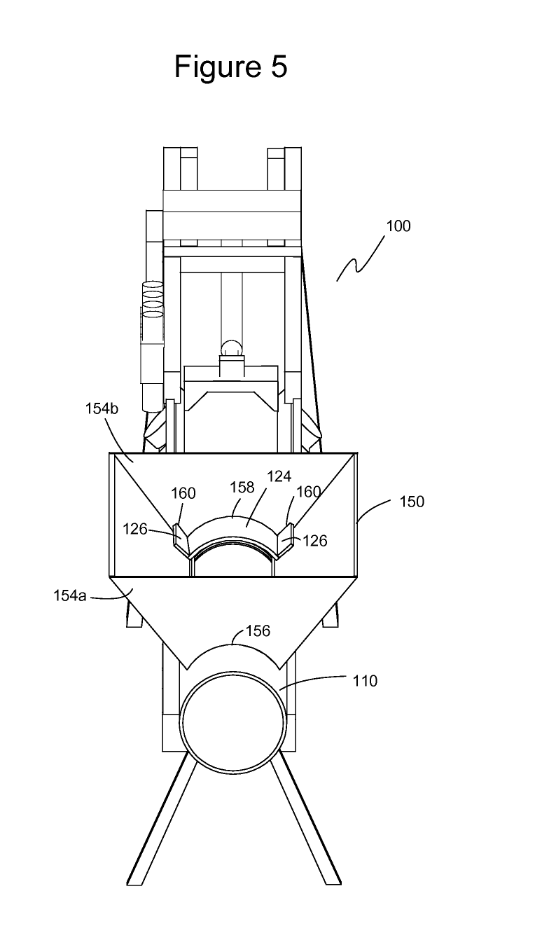

Referring now to FIG. 5, a top, front, perspective view illustrates one embodiment of machine 100. As shown, hopper 150 has curved edges 156, 158 along front and rear end plates 154a, 154b, respectively, for attachment to a cylindrical conduit 110. Curved edge 158 is sized to allow door 124 to pass. Rear end plate 154b has slots 160 sized and shaped to permit guide flanges 126 to pass.

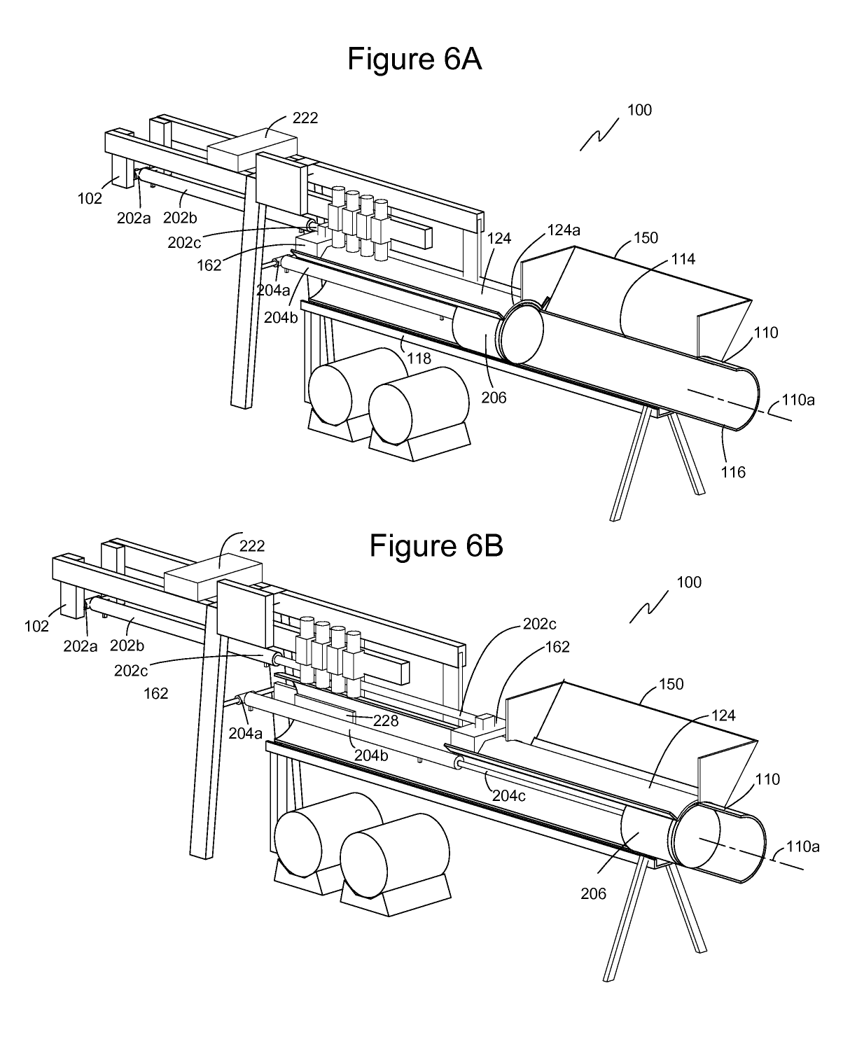

Referring now to FIGS. 6A and 6B, side views illustrate machine 100 shown with portions of conduit 110 and hopper 150 removed to more clearly show operation of pistons 202, 204. In FIG. 6A, pistons 202, 204 are shown in a first position (open) and in FIG. 6B are shown in a second position (closed). First piston 202 has a first piston distal end 202a, a first piston cylinder 202b and a first piston rod 202c. First piston rod 202c connects to door 124 to operate door 124 between open and closed positions. In one embodiment, door 124 includes a piston connecting member 162. Piston connecting member 162 is a block, bracket, protrusion, or other structure that permits connection of first piston rod 202c to door 124.

First piston rod 202c attaches to piston connecting member 162 on door 124 to move door 124 between its first position (open/retracted) and its second position (closed/extended). In one embodiment, piston connecting member 162 is positioned about four to five feet from a forward end 124a of door 124 so that when door 124 is in its second position (closed/extended), piston connecting member 162 is close to, but outside of hopper 150 as shown in FIG. 6B. In its first position, door 124 is retracted to uncover feed opening 114 so straw or other filling material can enter conduit 110 through feed opening 114. In its second position shown in FIG. 6B, door 124 is positioned to cover feed opening 114 to prevent entry of filling material 10 and other objects.

Second piston 204 (shown in FIGS. 6A, 6B) has a second piston distal end 204a, a second piston cylinder 204b, and a second piston rod 204c. Second piston distal end 204a is connected to frame 102. In one embodiment, all or a majority of second piston cylinder 204b is disposed in a rearward end portion 118 of conduit 110 with second piston rod 204c aligned along central longitudinal axis 110a of conduit 110. Second piston 204 connects to plunger 206 to move plunger 206 between a retracted position and an extended position within conduit 110. With its movement from the first position to the second position, plunger 206 pushes filling material 10 through conduit 110 towards and into flexible tube 20 attached over forward end portion 116 of conduit 110.

Optionally, one or more tube frame members 228 are attached within or extend into conduit 110 to support, attach, and/or stabilize second piston 204. In one embodiment, second piston 204 is attached to tube frame members 228 that extend into conduit 110 and also connect to legs 230 of frame 130. In other embodiments, conduit 110 has a reduced length (e.g., about 5-6 feet) compared to embodiments shown in FIG. 6A (e.g., about 10-12 feet) so that second piston cylinder 204b is partially or completely outside of conduit 110. In such an embodiment, second piston rod 204c extends to connect to plunger 206 located within conduit 110.

In one embodiment, first piston 202 and second piston 204 are hydraulic piston cylinders with a 2.5″ diameter bore, 1.5″ diameter rod, and a 54″ stroke length. First and second pistons 202, 204 preferably have progressive cushions on both ends to dampen stopping impact forces when the piston reaches the end of its stroke. First and second pistons 202, 204 are preferably configured to operate at about 65 inches per second in regeneration mode with regeneration control unit 222 operating at a range of 1000 to 4000 psig and more preferably at about 1200 psig. With a 54″ stroke, each of first piston 202 and second piston 204 completely extends piston rods 202c, 204c, respectively, within about 1.5 seconds.

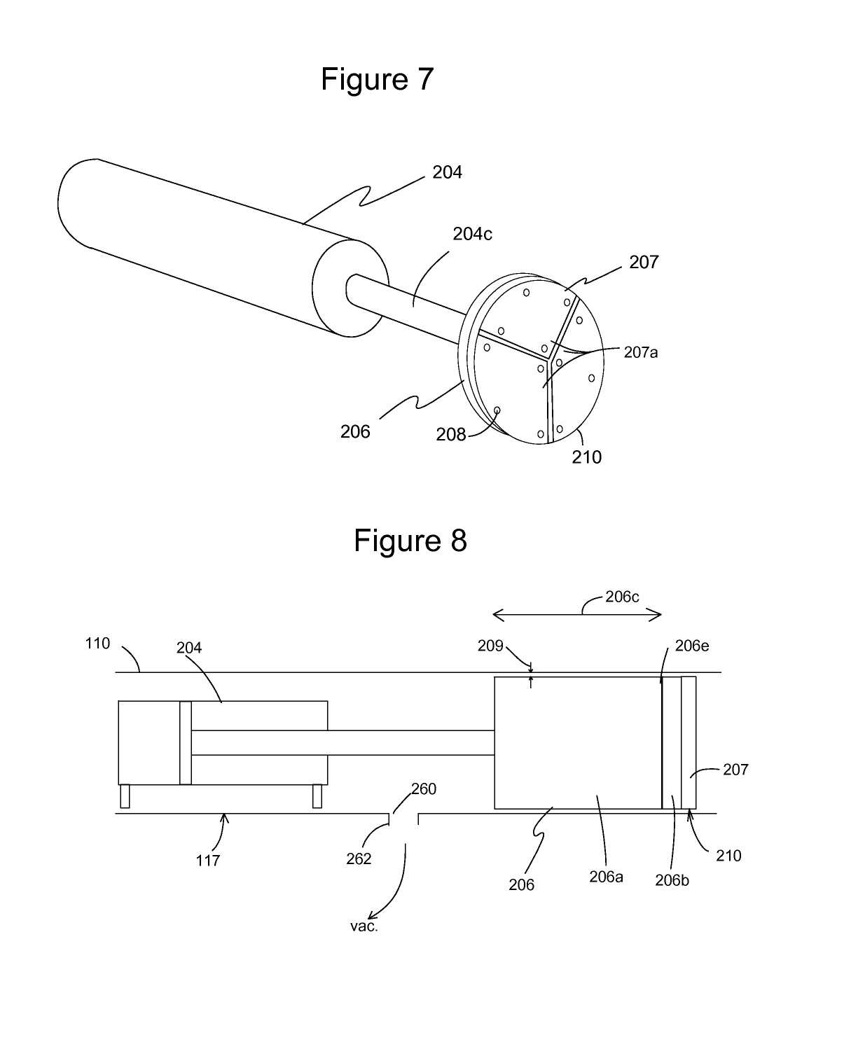

Referring now to FIG. 7, a perspective view illustrates one embodiment of second piston 204 with plunger 206 attached to second piston rod 204c. Plunger 206 has a shape and size substantially matching the cross-sectional shape and size of forward-end opening 111 of conduit 110. In one embodiment, plunger 206 includes a plunger plate 207 or disk with a shape substantially matching the cross-sectional shape of forward-end opening 111. Plunger plate 207 in one embodiment is made of plastic (e.g., ⅝″-thick UHMW polyethylene) and is fixedly attached to plunger 206 with fasteners 208, adhesive, or other methods. Plunger plate 207 optionally comprises a plurality of plunger plate sections 207a. For example, plunger plate 207 has three or four plunger plate sections 207a that divide plunger plate 207 into sectors.

Referring now to FIG. 8, a side view illustrates another embodiment of second piston 204 and plunger 206 disposed within conduit 110. Here, plunger 206 includes a plunger body 206a and a plunger body face plate 206b attached to forward end 206e of plunger body. In one embodiment, plunger body 206a is a solid cylinder, hollow cylinder with solid ends (including or in addition to plunger face plate 206b), or annulus made of metal or plastic. Plunger body face plate 206b is made of metal about 1″ in thickness or other rigid material. Plunger body 206 has a plunger body length 206c of about 8″-16″ along conduit 110, and typically about 12″. With this increased dimension compared to plunger 206 shown in FIG. 7, plunger 206 prevents, minimizes, or reduces the amount of filling material from falling behind plunger 206 during operation (e.g., towards piston cylinder 204b). Plunger plate 207 attaches to plunger body face plate 206b or directly to plunger body 206a. To further prevent filling material from falling behind plunger 206, a gap 209 between a perimeter edge 210 of plunger plate 207 and inside surface 113 of conduit 110 preferably is less than ¼″, typically less than ⅛″, and even more typically less than 1/16″.

In one embodiment, conduit 110 includes one or more exhaust openings 260 with optional connector 262 for connecting exhaust opening 260 to a vacuum system (not shown). In one embodiment, exhaust openings 260(s) is (are) positioned along a bottom portion 117 of conduit 110 since dust, particles, and small pieces of filling material tend to collect there. Other locations, including sides of conduit 110, are acceptable for exhaust openings 260. In another embodiment, longitudinal member 107 used to support conduit 110 is U-shaped as shown in FIG. 1. This U-shape defines a channel that can be used as part of a vacuum system. For example, longitudinal member 107 collects dust, particles, and small pieces of filling material 10 that pass through one or more exhaust openings 260. Longitudinal member 107 is then connected at one or both ends (or at other locations) to a vacuum system to remove the dust, particles, and small pieces.

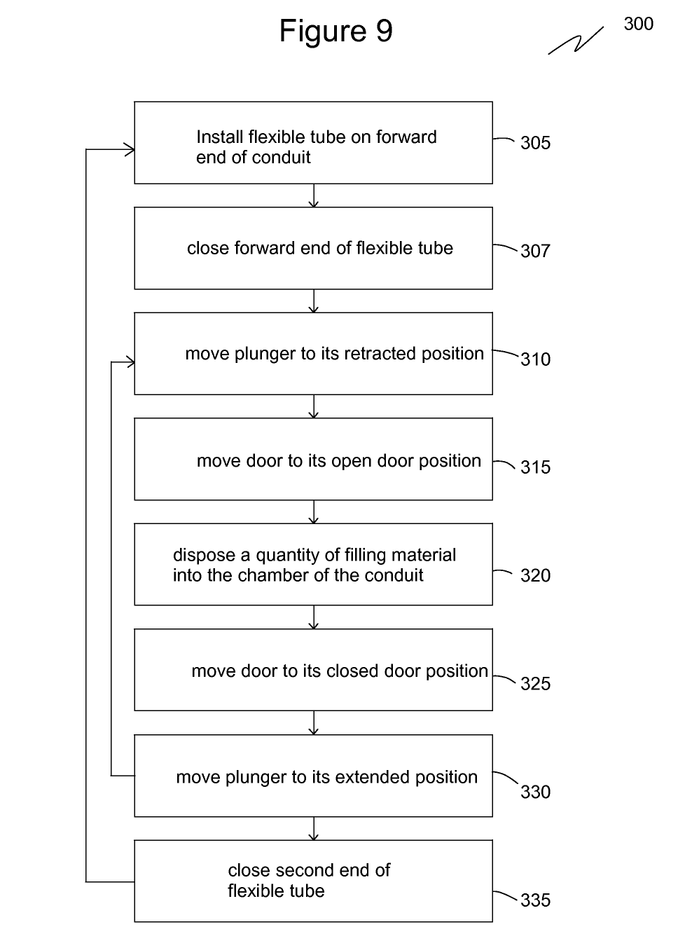

Referring now to FIG. 9, a flow chart illustrates steps performed in one embodiment of a method 300 of making bio logs. An example embodiment of machine 100 is shown in FIG. 10 with flexible tube 20 and filling material 10. Method 300 can be performed using embodiments of machine 100 described above. In step 305, a quantity of flexible tube 20 is rucked or disposed in a compressed or bunched condition over forward end portion 116 of conduit 110. Flexible tube 20 can be plastic netting, a woven fabric “sock”, or other flexible tubular structure made of any material to be filled with filling material 10. Filling material 10 may be straw, wood chips, sand, cellulose, rice straw, oat straw, compost, wood fiber, or any loosen feed stock material capable of being dispensed into hopper 150 and moved through conduit 110 by piston 206. In optional step 307, forward end 20a of flexible tube 20 is closed, for example, by tying, using a crimp, or applying a fastening device.

In step 310, if not already in the first position, second piston 204 retracts plunger 206 to its first, retracted position. In step 315, first piston 202 retracts door 124 to its first, open position. In one embodiment, step 315 occurs at the same time or after step 310 by approximately one second.

In step 320, rotary paddle system 250 or other material dispenser or feed device known in the art dispenses filling material 10 (e.g., straw, wood chips, sand, etc.) into hopper 150 and/or pushes filling material 10 through feed opening 114 into chamber 115. Optionally, step 320 may be performed manually, by gravity feed, or by a combination of these methods. Examples of acceptable material dispensers include hoppers, conveyors, paddles, and augers.

In step 325, first piston 202 extends to move door 124 to its second, closed position where it covers feed opening 114. In doing so, door 124 in some embodiments cuts off any filling material 10 that extends from chamber 115 through feed opening 114.

In step 330, second piston 204 extends to move plunger 206 through chamber 115 of conduit 110, preferably to at least front end plate 154a or beyond. In doing so, plunger 206 pushes filling material 20 through chamber 115 towards forward-end opening 111 and into flexible tube 20. In one embodiment using filling material 20 made of straw, for example, approximately four linear feet of straw in chamber 115 is compressed to fill about 12″ to 18″ of flexible tube 20. In one embodiment, step 330 occurs slightly after step 325 to prevent filling material 20 from clogging or becoming entangled with second piston 204. By repeating steps 310-330 as needed, filling material 10 is pushed through conduit 110 by plunger 206 to fill flexible tube 20 as flexible tube 20 uncoils from forward end portion 116 of conduit 110. Optionally, control unit 234 receives a signal or detects that one cycle is complete, thereby indicating that a subsequent cycle may begin. In one embodiment, control unit 234 is configured to pause method 300 after a predefined number of iterations or cycles through selected steps (e.g., 25 iterations of steps 310-330), to allow time for an operator to remove one completed product (e.g., a bio log) and prepare flexible tube 20 and/or machine 100 to begin method 300 again. For example, an operator removes a completed bio log from the area and obtains another quantity of flexible tube. Operator is then ready to being method 300 at step 305 with disposing flexible tube 20 over conduit 110.

In optional step 335, when the quantity of flexible tube 20 is filled to a desired capacity, the second end of flexible tube 20 that was attached to conduit 110 is closed to retain filling material 10. In a production setting, for example, after completing step 335, method 300 may be repeated from step 305 to produce additional filled-tube products, such as bio logs.

In one embodiment, hydraulic assembly 200 of machine 100 is configured to perform steps 310 through 330 in a cycle having a period of about five to eight seconds and more preferably between 5 seconds and 7.2 seconds. The cycle period as a whole or the timing of any one or more steps is adjustable depending on the type of filling material 10 or physical properties of the filling material 10 at the time of operation. For example, the cycle period as a whole is adjustable between 5 and 7.2 seconds to accommodate the moisture content, density, and other characteristics of the filling material. For example, the cycle period is increased to accommodate the physical properties of wet and frozen straw. In another embodiment, the timing or duration or one or more individual steps is adjustable to accommodate different conditions of filling material 10. For example, the time to extend second piston 204 or delay between first piston 202 and second piston 204 can be increased or decreased for different filling materials 10 or filling material 10 of different moisture content

In another embodiment, the cycle is 6.7 seconds. In one embodiment, first piston 202 and second piston 204 each extend to the second position (closed) in about 700 msec to about 900 msec. In one embodiment, first piston 202 extends door 124 to the closed position in about 775 msec and second piston 204 extends the plunger 206 to the closed position in about 825 msec. First and second pistons 202, 204 in one embodiment return to the first position (door open, plunger retracted) in the same amounts of time as is required to extend to the second position. In one embodiment, the time elapsed for first and second pistons 202, 204 individually or both together to return from the second (closed) position to the first (open) position is between 1000-1800 msec. In one embodiment, this timing of first and second pistons 202, 204 to return to the first position is dependent on the timing and operation of rotatry paddle system 250.

Machine 100 advantageously enables production of bio logs and other filled-tube products with a production output that is three times the production output of auger-based machines of the prior art. Additionally, machine 100 greatly reduces dust compared to blower-based machines and produces bio logs having greater consistency of fill density. Further, when machine 100 operates with straw filling material 10, the straw can be 2-4″ in length or more, thereby eliminating the need to cut the straw into smaller pieces as is required by auger-based machines. Further, machine 100 is more durable than prior art machines and can be used inside a structure without concerns about dust.

Although the preferred embodiments of the present invention have been described herein, the above description is merely illustrative. Further modification of the invention herein disclosed will occur to those skilled in the respective arts and all such modifications are deemed to be within the scope of the invention as derailed by the appended claims.

What is claimed is:

1. An apparatus for making a bio log comprising:
a conduit having a forward end, a rearward end, and defining a chamber with a feed opening along a top surface of the conduit, wherein the forward end is configured to accept a predefined quantity of flexible tube material to be filled;
a door slidably disposed on the conduit and configured to open and close the feed opening by sliding along the conduit from a first door position to a second door position;
a first piston connected to the door and configured to reciprocally move the door between the first door position wherein the opening is substantially unobstructed by the door, and the second door position wherein the opening is substantially closed by the door;
a plunger disposed within the conduit; and
a second piston connected to the plunger and configured to reciprocally move the plunger longitudinally along the chamber between a first plunger position and a second plunger position when the door is in the second door position.

2. The apparatus of claim 1, further comprising a hopper disposed above the feed opening.

3. The apparatus of claim 1, further comprising a first hydraulic pump connected to the first piston and a second hydraulic pump connected to the second piston.

4. The apparatus of 3, wherein the first piston and the second piston are each piped in a hydraulic regeneration circuit.

5. Apparatus of 4, further comprising a controller configured to operate the first piston and the second piston in a repeating cycle.

6. The apparatus of claim 1, wherein the conduit defines at least one exhaust opening.

7. The apparatus of claim 6, further comprising a vacuum line attached to the at least one exhaust opening.

8. The apparatus of claim 1, further comprising a material dispenser disposed above the feed opening, the material dispenser including an element selected from the group consisting of a paddle, an auger, a conveyor, and a hopper.

9. A method of making a bio log using a longitudinal conduit defining a chamber with a feed opening and having a forward end portion with a forward-end opening, a plunger disposed within the longitudinal conduit, and a door on the conduit movable between an open door position and a closed door position, the method comprising:
disposing a predefined quantity of filling material into the chamber;
moving the door to the closed door position;
moving the plunger along the chamber in the direction of the forward end portion, thereby pushing the quantity of filling material towards the forward-end opening;
retracting the plunger from the chamber; and
retracting the door to the open door position;
wherein the steps of disposing a quantity of filling material, moving the door to the closed door position, moving the plunger through the chamber, retracting the plunger from the chamber, and retracting the door to the open door position comprise one cycle.

10. The method of claim 9, wherein the steps of moving the plunger and retracting the plunger are performed with a first hydraulic piston connected to the plunger and wherein the steps of retracting the door and moving the door are performed with a second hydraulic piston connected to the door.

11. The method of claim 10, further comprising:
installing one end of a flexible tube on a forward end portion of the longitudinal conduit, wherein the flexible tube receives the predefined quantity of filling material from the forward-end opening.

12. The method of claim 11, further comprising:
closing a forward end of the flexible tube.

13. The method of claim 10, further comprising:
operating the first hydraulic piston in a regeneration circuit; and
operating the second hydraulic piston in a regeneration circuit.

14. The method of claim 10, wherein the one cycle of the method is performed in less than eight seconds.

15. The method of claim 10, wherein the one cycle of the method is performed in less than 7.2 seconds.

16. The method of claim 13, further comprising:
repeating the method a predetermined number of cycles;
pausing the method for a predetermined length of time; and
starting the method again for the predetermined number of cycles.
